(19) United States
(12) Patent Application Publication
(10) Pub. No.: US 2005/0021651 A1
(43) Pub. Date: Jan. 27, 2005

(54) Method and system for identification and presentation of statistical usage data for messaging systems

(75) Inventors: Craig William Fellenstein, Brookfield, CT (US); Carl Phillip Gusler, Austin, TX (US); Rick Allen Hemilton II, Charlottesville, VA (US); James Wesley Seaman, Falls Church, VA (US)

Correspondence Address: Rudolf O. Siegesmund, Suite 2000, 4627 N. Central Expressway, Dallas, TX, 75205-4017, US

(73) Assignee: International Business Machines Corporation, Armonk, NY (US)

(21) Appl. No.: 10/626,194

(22) Filed: Jul. 24, 2003

(51) Int. Cl. G06F 15/16

(52) U.S. Cl. 709/207; 709/228

(57) ABSTRACT

An apparatus and method for facilitating communication through a messaging system by identifying times when a user of the system is most likely to be available for a messaging session. The apparatus comprises an event monitor, a database, a usage processor, and a usage indicator. The event monitor detects messaging system events and records information about these events in the database. The usage processor retrieves the recorded information from the database and uses the information to compiles statistical usage data for a given user. The usage indicator then displays the statistical usage data in a summary format to an end user. In the preferred embodiment, the event monitor, usage processor, and usage indicators are all implemented as computer instructions. These three components may be executed independently of each other, or they may be integrated into a single computer program. Similarly, each component may operate independently or be integrated into an existing messaging system.

### FIELD OF THE INVENTION

The present invention relates generally to electronic communications systems and, in particular, to messaging systems used in a networked computing environment.

### BACKGROUND OF THE INVENTION

Instant messaging systems provide an alternative to traditional communication systems, such as the telephone and fax machine. These messaging systems have assumed an important role in business and personal communication, and continue to gain popularity.

An instant messaging system allows people to communicate in real time through computers connected in a network. Usually an instant messaging system allows users to exchange electronic text messages. A first user types a message on a keyboard connected to that first user's computer and that message is immediately sent to and displayed as text on a second user's computer. The second user can respond, if desired or needed, by typing a new message. That new message is then sent back to and displayed as text on the first user's computer. By repeating this process, the first and second user can carry on a typed conversation over the network.

Each user in an instant messaging system is usually identified by a unique number or address. Typical messaging systems also include a means for indicating when a particular user is signed into the messaging system and available for an online messaging session. A common indicator is an icon appearing on other users' displays that provide a potential recipient's name and/or address. A user can establish a two-way communication link by sending a message to any other user that the system indicates is online. Users usually have some control over which users can view their online status, and which users' status they want to see displayed on their own computer. Access control usually takes the form of an address list. An address list comprises entries corresponding to other users of the messaging system. Each entry typically contains information about the other user's identity and/or address and whether or not that user's online status is of interest to the owner of the address list. The address list is, of course, as much for security as for convenience. An address list allows a user to filter out unwanted information about other users. An address list also allows a user to limit unwanted monitoring by other users. Many instant messaging systems also allow more than two people to engage in a single messaging session. An example of a comprehensive messaging system is disclosed in U.S. Pat. No. 6,484,196 (the '196 patent) entitled “Internet Messaging System and Method for Use in Computer Networks.”

But current instant messaging systems do not address the problem of predictive timing. The problem of predictive timing refers to the need of a first user to know when a second user will be available for contact via a given communications method. Users generally have no way of knowing when other users will be online and available for an instant messaging session unless they make arrangements in advance. A lack of predictive timing among users reduces an instant messaging system's reliability, and users often waste time and effort attempting to make initial contact with other users. Thus, the ability to monitor a particular user's usage patterns and determine when that particular user is most likely to be online would make instant messaging systems more reliable and less time consuming. U.S. Pat. No. 6,519,639 (the '639 patent) discloses a method of monitoring a user's activity in a messaging session, but it does not teach a method of monitoring the aggregate usage patterns that are needed in order to provide predictability. Therefore, a need exists in the art for a system and method of monitoring a user's aggregate usage patterns and using those patterns to predict when the user is most likely to be online and available for a messaging session.

### SUMMARY OF THE INVENTION

The present invention comprises a predictive timing system (PTS) that facilitates communication through a messaging system by identifying times when a user of the system is most likely to be available for a messaging session. The PTS comprises an event monitor (EM), a usage database (UDB), a usage processor (UP), and a usage indicator (UI).

The EM continuously monitors activity on the messaging system. The EM records event data in the UDB as events are detected. The UDB functions as a central repository for PTS data. The EM could be configured to record every event that occurs on the messaging system, but could also be configured to compare each event with a watch list. A watch list would allow users (or an administrator) to filter the amount of data collected by limiting the recording to particular types of events included in the watch list. The data collected could be very generic, such as the time of day that a user signs into the messaging system and the length of time that the user was signed in. But data could also be much more specific and include such information as the number of messages sent or received during a particular time frame. Other types of event data will be obvious to a person of ordinary skill in the art, and the examples just given are only intended to be illustrative and not limiting.

The UP retrieves event data from the UDB and compiles statistical data models that reflect a user's usage patterns. A typical set of data models might include the number of hours per day that a user spent online framed in time blocks of consecutive online hours, or the number of consecutive hours spent online within specific time frames such as business hours or weekends. Again, this list is intended to be illustrative and not limiting. The number and types of data models that could be prepared are virtually unlimited and could easily be tailored to meet any need.

Finally, the usage indicator would present these statistical data models as a summary usage report to the end user. Typically, the usage report would be presented in the form of a chart or table that allow the end user to readily determine the best time to contact another user for an online messaging session.

### BRIEF DESCRIPTION OF DRAWINGS

FIG. 1 is a depiction of a typical networked computing environment in which the present invention could be implemented.

FIG. 2 represents the memory configuration of a typical computing workstation using the present invention; and

FIG. 3 is a functional block diagram illustrating the operation of the event monitor.

FIG. 4 is an example of the contents of a usage database recorded by the event monitor.

FIG. 5 is a functional block diagram illustrating the operation of the usage processor and usage indicator to prepare and display statistical data to the end user.

FIG. 6 is an example of the contents of a typical address list with access properties.

FIG. 7 depicts the type of statistical data that usage processor could produce.

FIG. 8 is an example of a usage report that usage indicator could produce.

FIG. 9 is another example of a usage report that usage indicator could produce.

### DETAILED DESCRIPTION OF THE PREFERRED EMBODIMENT

As used herein, the term “access list” means any mechanism that enables an individual messaging system user to exercise control over the accessing and viewing of their usage data by other messaging system users.

The term “database” means any collection of data stored together and organized for rapid search and retrieval, including without limitation flat file databases, fielded databases, full-text databases, object-oriented databases, and relational databases.

The term “messaging system” refers to any means of transmitting an electronic message from one user to another.

The term “record” means any action that causes information to be saved in a temporary or persistent storage medium.

The term “system event” means any occurrence that is significant to a messaging system or a significant point in time when a unique system process occurs within a messaging system.

The term “watch list” refers to any mechanism that enables a messaging system user or administrator to identify types of messaging system events to be recorded when detected.

In the preferred embodiment of the PTS, the EM, UP, and UI are all implemented as computer instructions. But a person of ordinary skill in the art will appreciate that EM, UP, and UI components could be configured in many different ways. For example, the EM, UP, and UI components may operate independently of each other, or they may be integrated into a single computer program. Similarly, each component may operate independently or be integrated into an existing messaging system. Moreover, each component may be implemented as either a hardware component or a software component, or any combination of the two.

The present invention operates in conjunction with a messaging system. The discussion below is presented in the general context of an instant messaging system implemented across a computer network, but a person of ordinary skill in the art will appreciate that the invention is also applicable to other types of messaging systems, including email and electronic bulletin board systems.

Furthermore, a user interacts with the PTS through a graphical user interface (GUI). A person of ordinary skill in the art will be familiar with the various types of GUIs commonly used, including graphical window systems, and they need not be described in greater detail herein. The foregoing and other objects, features, and advantages of the invention will be apparent from the following more particular description of the preferred embodiment of the invention, as illustrated in the accompanying drawings wherein like reference numbers represent like parts of the invention.

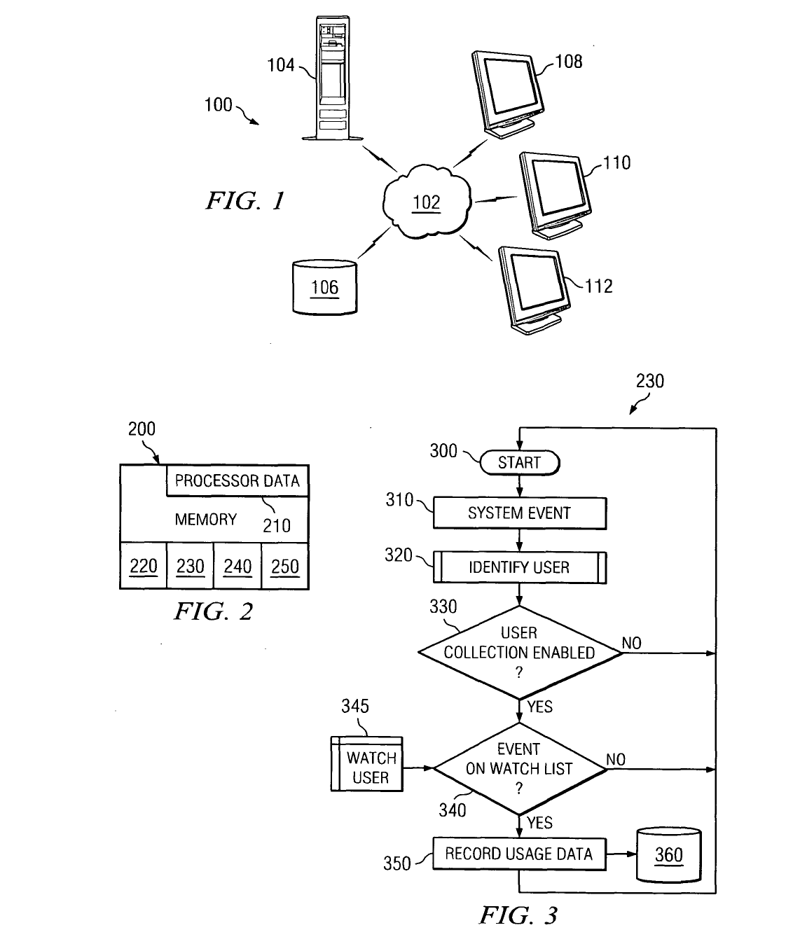

FIG. 1 is an illustration of computer network 100 associated with the present invention. Computer network 100 comprises local workstation 108 electrically coupled to network connection 102. Local workstation 108 is electrically coupled to remote workstation 110 and remote workstation 112 via network connection 102. Local workstation 108 is also electrically coupled to server 104 and persistent storage 106 via network connection 102. Network connection 102 may be a simplified local area network (LAN) or may be a larger network such as a wide area network (WAN) or the Internet. Furthermore, computer network 100 depicted in FIG. 1 is intended as a representation of a possible operating network that may contain the present invention and is not meant as an architectural limitation.

The internal configuration of a computer, including connection and orientation of the processor, memory, and input/output devices, is well known in the art. The present invention is a methodology that can be embodied in a computer program. Referring to FIG. 2, the methodology of the present invention is implemented in conjunction with messaging system 220. Messaging system 220 enables two-way communication between users of local workstation 108, remote workstation 110, and remote workstation 112 over network connection 102. The components of the present invention comprise EM 230, UP 240, and UI 250, all of which reside in memory 200. Messaging system 220, EM 230, UP 240, and UI 250 described herein can be stored within memory 200 of any workstation or server depicted in FIG. 1. Alternatively, messaging system 220, EM 230, UP 240, and UI 250 can be stored in an external storage device such as persistent storage 106, or a removable disk such as a CD-ROM (not pictured). The present invention further comprises UDB 360 (see FIG. 3) that could also be stored in memory 200 or an external storage device such as persistent storage 106, or a removable disk such as a CD-ROM. Memory 200 is only illustrative of memory within one of the machines depicted in FIG. 1 and is not meant as a limitation. Memory 200 also contains processor data 210. The present invention may interface with processor data 210 through memory 200.

In alternative embodiments, messaging system 220, EM 230, UP 240, and/or UI 250 can be stored in the memory of other computers. Storing messaging system 220, EM 230, UP 240, and/or UI 250 in the memory of other computers allows the processor workload to be distributed across a plurality of processors instead of a single processor. Further configurations of messaging system 220, EM 230, UP 240, and UI 250 across various multiple memories and processors are known by persons skilled in the art.

FIG. 3 provides a functional block diagram illustrating the operation of EM 230. In the preferred embodiment, both messaging system 220 and EM 230 are in continuous operation. Thus, once EM 230 starts (300) it constantly monitors messaging system 220 for system events (310). System events include, for example, such things as a user signing in or out of the messaging system, or a message being sent or received. When EM 230 detects a system event, EM 230 identifies the user (320) that caused the system event. Although not required, the preferred embodiment allows each user of messaging system 220 to disable the collection of their own usage data. Thus, EM 230 must determine whether the user that has been identified allows usage data collection (330). If not, EM 230 simply starts over and waits for the next system event (310). But if usage data collection is appropriate, EM 230 determines if the type of system event is contained in watch list 345 (340). Watch list 345 could exist in various forms, such as a separate text file that is read by EM 230, or it could reside in database 360. Persons with skill in the art will appreciate the many forms that watch list 345 could assume and these forms need not be described in greater detail herein. Finally, if user collection is enabled and the system event is included in watch list 345, EM 230 records system event data (350) in UDB 360. EM 230 then waits for the next system event and repeats this cycle.

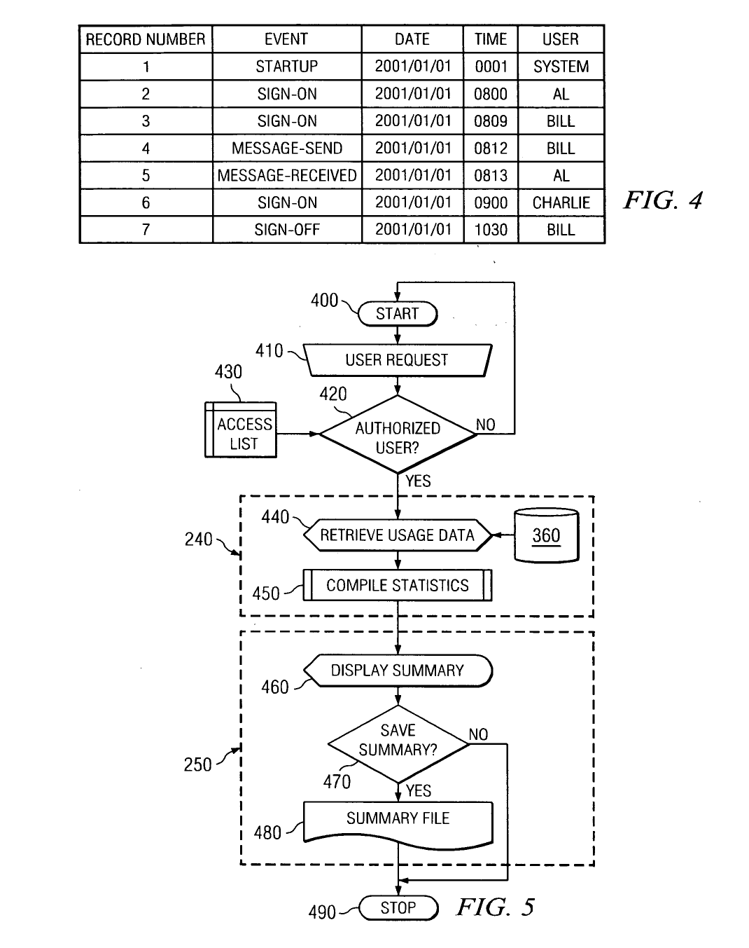

FIG. 4 illustrates the type of data that EM 230 might collect and record in UDB 360. In FIG. 4 each column heading in the first row represents a typical field name that could be used in UDB 360. Each row in FIG. 4 represents a system event record. Thus, in the example, UDB 360 indicates that the user identified by the unique address ‘al’ signed on to the messaging system at 8:00 a.m. on the morning of Jan. 1, 2001 (record no. 2). Records no. 3 and 4 indicate that user ‘bill’ signed on nine minutes later and sent an instant message to ‘al’ at 8:12 a.m. User ‘al’ received the message from ‘bill’ almost immediately, at 8:13 a.m., according to record no. 5. Record no. 6 indicates that a third user, ‘charlie,’ signed on at 9:00 a.m. Finally, record no. 7 indicates that ‘bill’ signed off at 10:30. This example is intended to be illustrative only, and not limiting the scope of the invention in any way. A typical database would likely contain thousands, or even millions, of records and could contain much more detailed data. Furthermore, a typical database would continue to grow with continued use of the messaging system. The discussion that follows demonstrates how the data illustrated in FIG. 4 would be used in a typical implementation of the PTS.

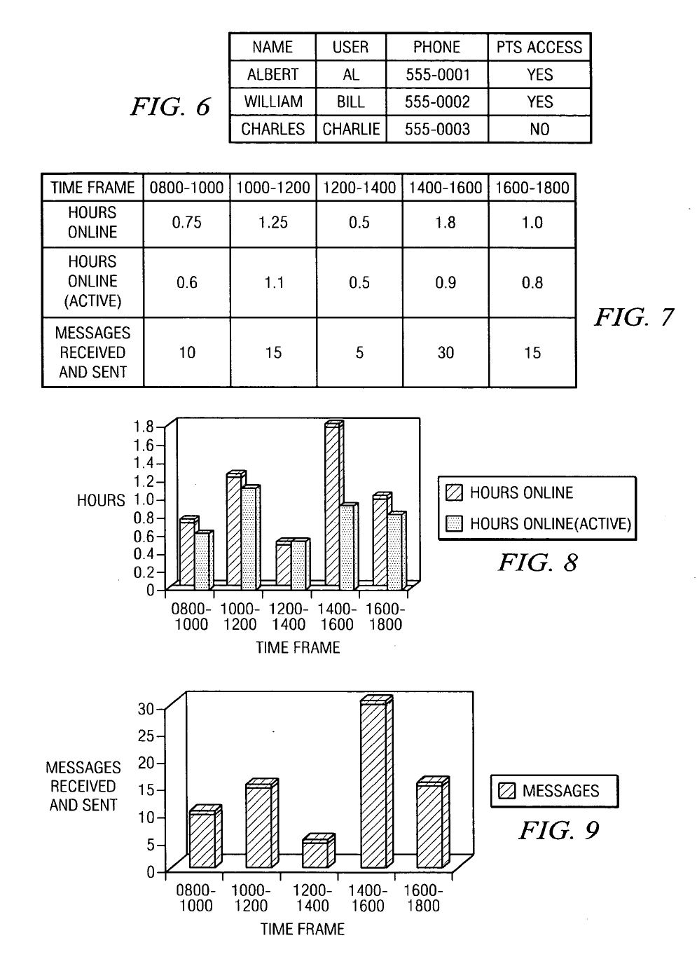

FIG. 5 is a functional block diagram illustrating the operation of the UP 240 and UI 250 to prepare and display statistical data to the end user. The process starts (400) when a first user of messaging system 220 makes a request for usage report on a second user. In the preferred embodiment, the first user would make this request by selecting the appropriate menu command or clicking a command button in the graphical user interface. Although not required, the preferred embodiment allows every user to restrict access to their own usage data to certain other users of messaging system 220. Each user of messaging system 220 would have an individual access list 430 that only they or an administrator could modify. Access list 430 would contain an entry granting or denying access to other particular users, or even groups of users. Access list 430 could have many forms, including that of a simple text file. Access list 430 could also be integrated with a user's address list. An illustration of second user's address list with access properties is provided in FIG. 6. Persons with skill in the art will appreciate the many forms that access list 430 could assume and these forms need not be described in greater detail herein. Thus, after a first user makes a request for a usage report (420) on a second user, second user's access list 430 is checked for appropriate authorization. Referring to the example in FIG. 6, if first user is ‘al’ then access to second user's usage data would be granted. If, however, first user was ‘charlie’ access to second user's usage data would be denied. If access is appropriate, UP 240 then retrieves second user's usage data (440) from UDB 360 and compiles statistics on second user's activity (450). A typical set of statistics might include the average time that second user signs on to messaging system 220 each day, or the number of messages received and responded to during any given time frame. FIG. 7 is an example of a set of statistics that could be collected for second user. The example data in FIG. 7 represents the data that UP 240 might collect about user ‘al’ (whose real name is Albert). UI 250 then uses the compiled statistics to prepare a summary usage report and displays it on first user's computer (460). FIG. 8 and FIG. 9 illustrate the type of summary usage report that UI 250 might produce based upon the example statistics provided in FIG. 7. First user then may optionally save the usage report (470) as a separate summary file 480. Otherwise the process ends (490).

It will be understood from the foregoing that various modifications and changes may be made in the preferred embodiment of the present invention by those skilled in the art without departing from its true spirit. It is intended that this description and the examples provided are for illustrative purposes only and should not be construed in a limiting sense. The scope of the invention should be limited only by the language of the following claims.

1. A programmable apparatus for identifying optimal times for an end user to contact a target user of a messaging system, comprising:
an event monitor to detect messaging system events and to record the messaging system events in a database;
a usage processor to compile statistical usage data from the events in the database; and
a usage indicator to display the target user's statistical usage data on an output device.

2. The apparatus of claim 1, wherein the messaging system is an instant messaging system.

3. The apparatus of claim 1, wherein the messaging system is an email messaging system.

4. The apparatus of claim 1, wherein the messaging system is an electronic bulletin board system.

5. The apparatus of claim 1, wherein the event monitor allows the target user to disable the recording of the target user's events.

6. The apparatus of claim 1 further comprising a watch list.

7. The apparatus of claim 6, wherein the event monitor only records events matching a type included in the watch list.

8. The apparatus of claim 1 further comprising an access list for the target user.

9. The apparatus of claim 8, wherein the usage processor compiles the target user's statistical usage data only if the end user is in the target user's access list.

10. The apparatus of claim 1, wherein the usage indicator saves the target user's statistical usage data in a summary file.

11. A computer readable memory for causing a computer to identifying optimal times for an end user to contact a target user of a messaging system, comprising:
a computer readable storage medium;
a computer program stored in the storage medium, wherein the storage medium, so configured by the computer program, causes the computer to
detect messaging system events;
record the messaging system events in a database;
compile the target user's statistical usage data from the messaging system events in the database; and
display the target user's statistical usage data on an output device.

12. The computer readable memory of claim 11, wherein the messaging system is an instant messaging system.

13. The computer readable memory of claim 11, wherein the messaging system is an email messaging system.

14. The computer readable memory of claim 11, wherein the messaging system is an electronic bulletin board system.

15. The computer readable memory of claim 11, wherein the computer program causes the computer to allow the target user to disable the recording of their own events.

16. The computer readable memory of claim 11 further comprising a watch list stored in the computer readable storage medium.

17. The computer readable memory of claim 16, wherein the computer program causes the computer to record only events matching a type included in the watch list.

18. The computer readable memory of claim 11 further comprising an access list for the target user, the access list being stored in the computer readable storage medium.

19. The computer readable memory of claim 18, wherein the computer program causes the computer to compile the target user's statistical usage data if the end user is in the target user's access list.

20. The computer readable memory of claim 11, wherein the computer program causes the computer to save the target user's statistical usage data in a summary file.

21. A method of identifying optimal times for an end user to contact a target user of a messaging system, comprising detecting messaging system events, recording the messaging system events in a database, compiling statistical usage data from the messaging system events, and displaying the target user's statistical usage data on an output device.

22. The method of claim 21, wherein the messaging system is an instant messaging system.

23. The method of claim 21, wherein the messaging system is an email messaging system.

24. The method of claim 21, wherein the messaging system is an electronic bulletin board system.

25. The method of claim 21, wherein the steps following the detecting step do not occur if the target user has disabled the recording of the target user's events.

26. The method of claim 21, wherein the recording step only records events matching a type included in a watch list.

27. The method of claim 21, wherein the compiling step only occurs if the end user is included in a target user's access list.
